(19) United States
(12) Patent Application Publication
(10) Pub. No.: US 2010/0220431 A1
(43) Pub. Date: Sep. 2, 2010

(54) Subsea Protection Device

(75) Inventor: Neil Douglas, Clevedon (GB)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: Viper Subsea Limited, Bristol (GB)

(21) Appl. No.: 12/548,722

(22) Filed: Aug. 27, 2009

(30) Foreign Application Priority Data
Sep. 15, 2008 (GB) 0816758.7

(51) Int. Cl. H02B 7/00; H01H 9/00

(52) U.S. Cl. 361/622; 200/237

(57) ABSTRACT

A subsea electrical protection device is described which comprises a re-settable circuit breaker 26 operable to open an electrical circuit in the event of the detection of a loss of insulation resistance and/or current leakage to earth. A subsea control system is also described which comprises an umbilical 12, a control device 14, and a subsea protection device 26 provided therebetween.

This invention relates to a subsea electrical protection device, for example for use with equipment used in the extraction of oil or natural gas from subsea locations or in other subsea applications, for example with the use of offshore electrical generation equipment.

Where fluids are extracted from subsea wells it is usual to use control equipment, often located on the sea bed, to control, for example, the pumping of fluids to the surface or to control a number of other functions. The control equipment is usually connected to a remote facility, for example at the surface or on land, by way of an umbilical through which electrical power and control signals are routed. The umbilical may also include hydraulic hoses or the like.

Where several control equipment devices are used, as is normally the case, a single umbilical is usually connected between the remote facility and a subsea distribution unit or node, separate cables and/or hoses connecting the distribution unit and the devices to distribute power and control signals therebetween.

The subsea environment is harsh and it is necessary to provide protection for the electrical circuits of the control equipment devices against damaging failures and to minimise the propagation of failures from one device to another.

The most common failure arising from the subsea environment is the failure of insulation, which may result in short circuits between conductors and/or current flow from the live conductor or conductors to earth.

It is common for the umbilical, distribution unit and connecting cables to incorporate a degree of redundancy so that if a fault occurs in one channel of the system, operation can be switched to take that channel out of service. Typically, surface or remotely located protection equipment is provided to monitor the insulation resistance and current flow in the umbilical. For example, the protection equipment may comprise conventional over-current circuit breakers, residual current circuit breakers and/or direct line insulation monitoring (LIM) of subsea insulation resistance. Such arrangements have the disadvantage that, when a fault is detected, an entire channel of the system is shut down even though much of the equipment and connecting cables associated with that channel is still fully operable.

It is also known to provide over-current protection devices in subsea locations, thereby getting around the problem of having to shut down an entire channel despite a large part of the channel still being operable, in some circumstances. The protection devices used in such subsea locations typically comprise transformers, fuses, line matching and current limiting resistor networks, positive temperature co-efficient thermistors, magnetic feedback inductive current limiting devices, and electronic isolation switching. These protection devices have also been used in combination with surface located protection equipment, care being taken to ensure that the protection systems do not interfere with one another, to provide an enhanced level of protection.

As some of the protected electrical cables may be used to carry control signals in addition to electrical power, it is important to ensure that the normal operation of the protection devices used does not interfere with the transmission of such signals.

It is an object of the invention to provide a subsea protection device of simple and convenient form. The invention also relates to a system incorporating such a device.

According to the present invention there is provided a subsea electrical protection device comprising a re-settable circuit breaker operable to open an electrical circuit in the event of the detection of a loss of insulation resistance and/or current leakage to earth.

The re-settable circuit breaker may be adapted to re-set upon removal or interruption of a supply of power thereto. Alternatively, it may be arranged to re-set upon removal of connection to the fault causing event.

Preferably the circuit breaker has a trip threshold that is adjustable, preferably remotely. For example, the trip threshold may be adjustable by physical intervention, by remote communications through water or in response to a signal transmitted along the umbilical, the threshold being adjusted with the circuit breaker in situ.

The invention further relates to a subsea control system comprising an umbilical, a control device, and a subsea protection device provided therebetween. Preferably a subsea distribution unit is connected between the umbilical and the control device, the subsea protection device being located within the subsea distribution unit. The subsea distribution unit preferably houses a plurality of such protection devices. The subsea distribution unit may include a plurality of distribution nodes, and each node conveniently has a plurality of protection devices associated therewith.

The invention will further be described, by way of example, with reference to the accompanying drawings, in which:

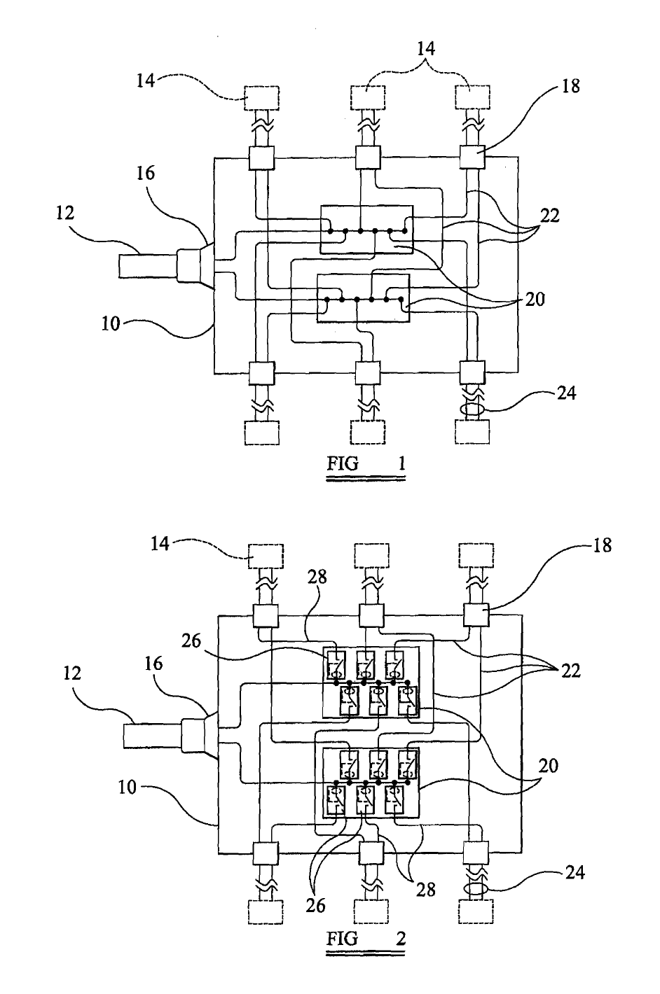

FIG. 1 is a diagrammatic illustration showing part of a typical subsea installation; and

FIG. 2 is a view similar to FIG. 1 but illustrating an installation in accordance with an embodiment of the invention.

FIG. 1 illustrates part of a typical subsea system which comprises a subsea distribution unit 10 operable to distribute power and control signals from the surface or another remote location received via an umbilical 12 to a series of well control equipment devices 14. An optional connector 16 allows the removable connection of the umbilical 12 to the subsea distribution unit 10, and connectors 18 permit disconnection and re-connection of each of the control equipment devices 14 to the subsea distribution unit 10, electrical cables or leads 24 connecting the devices 14 to the connectors 18.

Within the distribution unit 10 is located a pair of distribution nodes 20. Each node 20 is arranged to transmit power and/or control signals between the umbilical 12 and each of the control equipment devices 14. It will be appreciated, therefore, that each node 20 and the electrical cables or wires 22 associated therewith, forms a respective operating channel for the system, one channel providing redundancy or serving as a back up for the other channel.

In use, the channels are used in the distribution of supply and control signals between the umbilical 12 and the control equipment devices 14. In the event that surface or other remote located protection equipment determines that a fault has occurred in one of the channels associated with the subsea distribution unit 10 or the associated conductors of the umbilical 12 or connecting leads 24 connecting the control equipment devices 14 to the subsea distribution unit 10, the subsea distribution unit 10 is operated so that the faulty one of the channels is taken out of service.

Although such an arrangement provides a good level of electrical protection, it will be appreciated that in taking one of the channels out of services, a large part of the functionality of the subsea distribution unit 10 is taken out of service despite being fully operable. Taking a significant quantity of operable equipment permanently out of service represents a significant undesirable inefficiency.

FIG. 2 illustrates an arrangement in accordance with one embodiment of the invention. The arrangement of FIG. 2 is very similar to that of FIG. 1, and like reference numerals are used to denote like parts. Only the differences between the two arrangements will be described herein.

As shown in FIG. 2, each of the distribution nodes 20 houses a series of re-settable circuit breaker devices 26, each circuit breaker device 26 being associated with the electrical connection 28 connecting that node 20 to a respective one of the control equipment devices 14.

In normal use, initially power supply and control signals may be transmitted between the surface and each of the control equipment devices 14 via both of the nodes 20. In the event of a fault being sensed in the connections 28 connecting one of the nodes 20 to the connector 18 associated with one of the equipment devices 14, or in the event of a fault within the associated leads 24 or in the piece of equipment 14 itself, the associated one of the re-settable circuit breakers 26 will trip, isolating that control equipment device 14 from that one of the nodes 20. Power supply and control signals to the other control equipment devices 14 may continue without interruption, and power supply and control signals to that one of the control equipment devices 14 will continue, without interruption, via the other of the nodes 20.

Depending upon the nature of the fault, the tripped circuit breaker 26 may simply be re-set to re-establish the transmission of electrical power and control signals to the associated control equipment device 14 via both nodes 20. However, if the nature of the fault is such that this is not possible, the continued transmission of electrical power and control signals to that control equipment device 14 is via the said other one of the nodes 20 alone.

It will be appreciated that such an arrangement is advantageous in that a significant reduction in the quantity of operable equipment taken out of service in the event of a fault can be made. As the quantity of equipment taken out of service is reduced, it will be appreciated that the overall working life of the installation may be increased, leading to replacement cost savings.

Power may be supplied through the circuit breakers 26 in a number of ways and at a range of voltages within the scope of the invention. For example, a single phase AC supply, typically at 50/60 Hz, may be transmitted. Other options include 3 phase supplies, and single or three phase low frequency supplies. AC supplies may be in the range of, for example, 115Vᵣₘₛ to 1000Vᵣₘₛ. Alternatively, a DC supply, for example in the range of 24V to 1500V, may be used. Where communications signals are superimposed onto the power lines, thereby avoiding or reducing the need for separate control signals cables, the circuit breakers 26 should be designed so as to ensure that such signals are not blocked or attenuated to an unacceptable extent.

The circuit breakers 26 are protected for sea water penetration. The ambient pressure in many applications is of the order of 100 bar, but can be as high as 300 bar, and so water ingress due to ambient pressure can be a significant problem.

Each re-settable circuit breaker 26 may take a range of forms. For example, it may be sensitive to losses of insulation resistance or other factors leading to the leakage of electrical current to earth. The manner in which the re-settable circuit breaker 26 is re-set may also take a range of forms. For example, the re-settable circuit breaker 26 may be re-set by interrupting the supply of electrical power thereto. After interruption of the supply of electrical power to the re-settable circuit breaker 26 to re-set the circuit breaker 26, the re-establishment of the supply of electrical power to the circuit breaker 26 will result in normal operation thereof. Alternatively, the re-settable circuit breaker 26 may be arranged to re-set automatically upon removal of the connection thereof to a fault causing device. Thus if the fault which gave rise to the tripping of the circuit breaker 26 is a temporary fault, the circuit breaker 26 will re-set once normal operating conditions have been restored.

Preferably even once tripped, the circuit breaker 26 will continue to test or otherwise monitor the associated circuit for faults. The circuit breaker 26 is conveniently arranged to communicate the operating status of the associated circuits to the remote facility, for example by transmitting appropriate signals along a control line.

Each re-settable circuit breaker 26 is preferably designed to have an adjustable trip threshold. The trip threshold is preferably adjustable with the circuit breaker 26 in situ, and is preferably adjustable from a remote location. The trip threshold may be adjusted via physical subsea intervention, for example using an ROV device to adjust the circuit breaker 26. Alternatively, it may be adjustable via remote communications through water. In such an arrangement, the circuit breaker 26 may be sensitive to the occurrence of acoustic or electro magnetic signals transmitted through the water from a remote location. In response to the sensing of such signals, the circuit breaker 26 will automatically adjust its trip threshold. Another possibility is for the trip threshold to be controlled upon the transmission of appropriate control signals thereto along the umbilical.

Although in the arrangement described hereinbefore the circuit breakers 26 are located within the nodes 20, it will be appreciated that this need not always be the case and they may be located elsewhere. For example, it may be desirable to locate the resettable circuit breakers in the connectors 18, or elsewhere.

Most of the description hereinbefore is of the use of the invention in equipment used in the extraction of oil or natural gas from subsea locations. It will be appreciated, however, that the invention is also suitable for use in other applications. For example it may be used in offshore electrical generation applications. When used in such applications, it will be appreciated that the voltages concerned may be significantly higher than those outlined hereinbefore, and appropriate modifications to the components may be required in order to accommodate these voltages.

It will be appreciated that a wide range of modifications and alterations may be made to the arrangement described hereinbefore without departing from the scope of the invention.

1. A subsea electrical protection device comprising a re-settable circuit breaker operable to open an electrical circuit in the event of the detection of a loss of insulation resistance and/or current leakage to earth.

2. A device according to claim 1, wherein the circuit breaker is adapted to re-set upon removal or interruption of a supply of power thereto.

3. A device according to claim 1, wherein the circuit breaker is adapted to re-set upon removal of connection to the fault causing event.

4. A device according to claim 1, wherein the circuit breaker has a trip threshold that is adjustable.

5. A device according to claim 4, wherein the trip threshold is adjustable by physical intervention.

6. A device according to claim 4, wherein the trip threshold is adjustable by remote communications through water.

7. A device according to claim 4, wherein the trip threshold is adjustable in response to a signal transmitted along the umbilical.

8. A subsea control system comprising an umbilical, a control device, and a subsea protection device as claimed in any of the preceding claims provided therebetween.

9. A system according to claim 8, wherein a subsea distribution unit is connected between the umbilical and the control device, the subsea protection device being located within the subsea distribution unit.

10. A system according to claim 9, wherein the subsea distribution unit houses a plurality of such protection devices.

11. A system according to claim 10, wherein the subsea distribution unit includes a plurality of distribution nodes, and each node has a plurality of protection devices associated therewith.

12. A system according to claim 8, wherein the subsea distribution unit is connected to the control device by way of a connector, the connector (or part thereof) housing the protection device.
